(19) United States
(12) Patent Application Publication
(10) Pub. No.: US 2008/0172365 A1
(43) Pub. Date: Jul. 17, 2008

(54) Searching a database using a cellular telephone

(76) Inventors: Babur Ozden, Houston, TX (US); Raul Lorenzo, Madrid (ES); Jorge Mata, Las Matas (ES)

Correspondence Address: FISH & RICHARDSON PC, P.O. BOX 1022, MINNEAPOLIS, MN, 55440-1022, US

(21) Appl. No.: 11/700,725

(22) Filed: Jan. 31, 2007

Related U.S. Application Data
(60) Provisional application No. 60/884,631, filed on Jan. 12, 2007.

(51) Int. Cl. G06F 17/30

(52) U.S. Cl. 707/3

(57) ABSTRACT

Searching a database using an electronic device includes receiving a first text message from the electronic device, providing a first search query to the electronic device in response to the first text message, where first search query is incomplete, receiving a second text message from the electronic device, where the second text message includes a second search query, and where the second search query includes a completed version of the first search query, using the second search query to obtain a search of the database, and providing results of the search to the electronic device.

### CROSS-REFERENCE TO RELATED APPLICATION

This patent application claims priority to U.S. Provisional Application No. 60/884,631, which was filed on Jan. 12, 2007. The contents of U.S. Provisional Application No. 60/884,631 are hereby incorporated by reference into this application as if set forth herein in full.

### TECHNICAL FIELD

This patent application relates generally to searching a database using a cellular telephone and, more particularly, to searching the Internet using text messaging from any text-capable cellular telephone.

### BACKGROUND

Cell phones, which originally were used only for making and receiving telephone calls, have become capable of much more, particularly in recent years. For example, cell phones are now capable of Internet access (e.g., searching the Internet), text messaging, and downloading and playing audio and video.

However, conventional cell phone searching requires that the cell phone have a specialized application, such as a browser. Some cell phones, particularly those at lower price points, do not include the applications required to search the Internet.

### SUMMARY

This patent application describes methods and apparatus, including computer program products, for searching a database, e.g., Web sites, using a cell phone.

In general, in one aspect, this patent application describes searching a database using an electronic device. The searching process comprises receiving a first text message from the electronic device, providing a first search query to the electronic device in response to the first text message, where the first search query is incomplete, and receiving a second text message from the electronic device, where the second text message comprises a second search query, and where the second search query comprises a completed version of the first search query. The searching process also comprises using the second search query to obtain a search of the database, and providing results of the search to the electronic device. This aspect may also include one or more of the following features.

Multiple search queries may be provided to the electronic device in response to the first text message. The multiple search queries may be provided with the first search query, and at least some of the multiple search queries may be incomplete.

The searching process may comprise receiving a third text message from the electronic device, where the third text message comprises a third search query, and where the third search query comprises one of the multiple search queries that is not incomplete, conducting a search of the database using the third search query, and providing results of the search conducted using the third search query to the electronic device.

A hyperlink to the results of the search may be generated. Providing the results of the search may comprise providing the hyperlink to the electronic device. The electronic device may comprise a mobile telephone and the database may comprise the Internet. The first search query may comprise a question having a blank portion. The second search query may comprise the question with the blank portion filled-in.

In general, in another aspect, this patent application describes searching the Internet using a cellular telephone. The searching process comprises receiving a text message from the cellular telephone, using the text message to obtain information from the Internet, and providing the information to the cellular telephone. This aspect may also include one or more of the following features.

A hyperlink to the information may be generated. Providing the information may comprise providing the hyperlink to the cellular telephone. The text message may comprise a search query. Using the text message to obtain information may comprise using at least part of the search query to interact with a search engine to obtain a search of the Internet.

In general, in another aspect, this patent application describes a system comprising memory to store instructions that are executable and one or more processing devices to execute the instructions to implement a searching process comprising receiving a first text message from the electronic device, providing a first search query to the electronic device in response to the first text message, where the first search query is incomplete, and receiving a second text message from the electronic device, where the second text message comprises a second search query, and where the second search query comprises a completed version of the first search query. The searching process also comprises using the second search query to obtain a search of the database, and providing results of the search to the electronic device. The one or more processing devices are also configured to execute the instructions to implement an e-mail retrieval process comprising receiving a third text message from the electronic device, retrieving e-mail from one or more e-mail accounts in response to the third text message, generating a hyperlink to the e-mail, and sending the hyperlink to the electronic device.

The foregoing aspects may be implemented as methods, apparatus, systems, and/or articles of manufacture (e.g., one or more machine-readable media comprising instructions that are executable by one or more processing devices to perform the methods).

The details of one or more examples are set forth in the accompanying drawings and the description below. Further features, aspects, and advantages will become apparent from the description, the drawings, and the claims.

### DESCRIPTION OF THE DRAWINGS

FIG. 1 is a block diagram of a system for performing search and retrieval functions using a cell phone.

FIG. 2 is a flowchart showing a process to retrieve e-mail over the system of FIG. 1.

FIGS. 3A to 3I show graphical user interfaces generated by a cell phone that may be displayed during the course of the process shown in FIG. 2.

FIG. 4 is a flowchart showing a process to reply to e-mail over the system of FIG. 1.

FIGS. 5A and 5B show graphical user interfaces generated by a cell phone that may be displayed during the course of the process shown in FIG. 5.

FIG. 6 is a flowchart showing a process search a database over the system of FIG. 1.

FIGS. 7A to 7E show graphical user interfaces generated by a cell phone that may be displayed during the course of the process shown in FIG. 6.

### DETAILED DESCRIPTION

Described herein is a process for using text messaging to retrieve information, such as electronic mail (e-mail), using an electronic device, such as a cellular telephone (cell phone). To summarize, a user contacts a central service by texting a message using any text-capable electronic device, e.g., a cell phone. The central service interprets the text message as a request to retrieve e-mail from one or more pre-specified accounts. The central service contacts services that maintain the e-mail accounts, and retrieves text for any number of e-mail messages. The central service generates a hyperlink, defined by a uniform resource locator (URL), to the e-mail text, and forwards the URL to the user's electronic device. The user selects the URL to download the e-mail text to the electronic device.

Also described herein is a process for searching a database, such as the Internet/World Wide Web (WWW) using any text-capable cell phone. To summarize, a user texts a message to a central service in order to receive a predefined list of search queries, some of which may be incomplete (e.g., contain blanks). A user selects one of these search queries from the cell phone, fills in the blank(s), and texts the resulting query to the central service. The central service performs a database search using the query, and sends the results back to the user's cell phone. Filters may be applied at the central service to further customize a phone's search capabilities.

The following describes performing the foregoing processes using a cell phone; however, any electronic device may be used to perform either, or both of, the processes, such as a personal digital assistant (PDA), or a desktop or laptop computer.

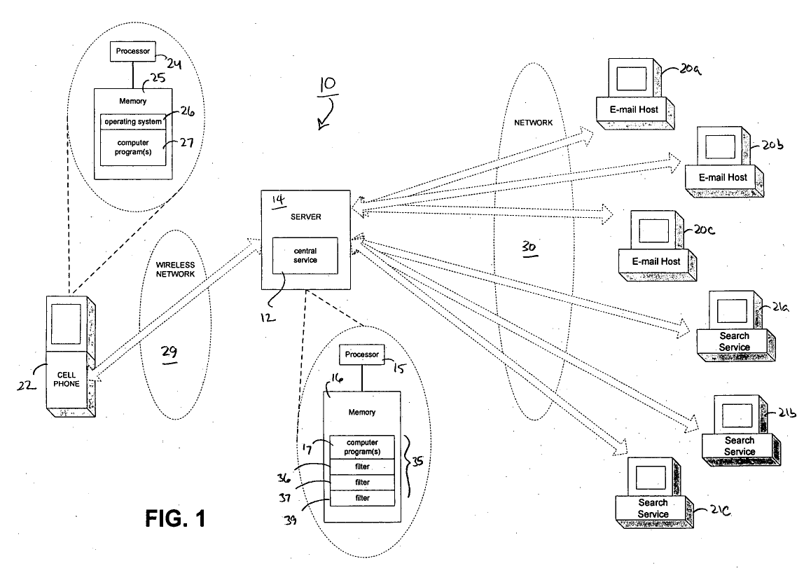

Referring to FIG. 1, system 10 includes a computer system that implements a central service 12 for retrieving e-mail messages and ordering database searches, as described above. The computer system acts as the intermediary between a cell phone that requests e-mail and an e-mail service that hosts e-mail, and between the cell phone and one or more search services for searching database(s), such as the Internet. In this implementation, the computer system includes a server 14. Server 14 may include one server or multiple constituent similar servers (e.g., a server farm). Although multiple servers may be used in this implementation, the following describes an implementation using a single server 14.

Server 14 may be any type of processing device that is capable of receiving and storing data, and of communicating with clients. As shown in FIG. 1, server 14 may include one or more processor(s) 15 and memory 16 to store computer programs that are executable by processor(s) 15. In this example, memory 16 stores one or more computer program(s) 17 for communicating with clients, such as cell phones, e.g., to receive, and respond to, requests. Computer program(s) 17 also include code for communicating with external servers, e.g., to request and receive content, such as e-mail messages from e-mail hosts 20a to 20c and/or information (e.g., search results) from search services 21a to 21c. Computer program(s) 17 implement at least part of central service 12.

More specifically, computer program(s) 17 receive a text message from a cell phone 22, interpret that message as a request to retrieve e-mail, contact one or more e-mail service(s) to retrieve the requested e-mail text, generate a URL to link to the e-mail text, and send the URL to the cell phone that requested the e-mail. A user at that cell phone selects (e.g., clicks-on) the URL in order to request the e-mail text, whereafter computer program(s) 17 send the e-mail text in response to the user's request.

Furthermore, computer program(s) 17 receive a text message from a cell phone 22, interpret that text message as a request for search queries, provide one or more search queries in response to the text message, receive a search query from cell phone 22, contact one or more search service(s) and instruct the search service(s) to conduct a search of one or more database(s) using the received search query, receive results of the search(es), generate a URL to link to the search results, and send the URL to cell phone 22. A user at that cell phone selects (e.g., clicks-on) the URL in order to request the search results, whereafter computer program(s) 17 send the search results in response to the user's request.

As described above, in this implementation, a cell phone is used to obtain e-mail and search results from central service 12. A cell phone may include any type of processing device that is capable of communicating with server 14, e.g., over a network, and that is capable of sending and receiving text messages. A cell phone 22 includes one or more processor(s) 24 and memory 25 that stores computer programs that are executed by processor(s) 24. Memory 25 stores an operating system 26, and a computer program(s) 27 that enable text messaging and other communication features. It is noted that the processes described herein for retrieving e-mail and for searching a database do not require that any special software or applications be downloaded to cell phone 22. Rather, as described below, these processes can be implemented using text messaging and other standard cell phone features.

Text messaging, or texting, is also referred to as the short message service (SMS), and is currently available on most new cell phones. The following excerpt, taken from wikipedia.org, describes how text messages are transmitted.

“Messages are sent to a Short Message Service Centre (SMSC) which provides a store-and-forward mechanism. It attempts to send messages to their recipients. If a recipient is not reachable, the SMSC queues the message for later retry. Some SMSCs also provide a “forward and forget” option where transmission is tried only once. Both Mobile Terminated (MT), for messages sent to a mobile handset, and Mobile Originating (MO), for those that are sent from the mobile handset, operations are supported. Message delivery is best effort, so there are no guarantees that a message will actually be delivered to its recipient and delay or complete loss of a message is not uncommon, particularly when sending between networks. Users may choose to request delivery reports, which can provide positive confirmation that the message has reached the intended recipient, but notifications for failed deliveries are unreliable at best.

Transmission of the short messages between SMSC and phone can be done through different protocols such as SS7 within the standard GSM MAP framework or TCP/IP within the same standard. . . . Larger content (known as long SMS or concatenated SMS) can be sent segmented over multiple messages, in which case each message will start with a user data header (UDH) containing segmentation information.”

Referring back to FIG. 1, e-mail hosts 20a to 20c are typically servers (e.g., server farms) or other computers that maintain Web sites, and that host e-mail accounts. Examples of e-mail hosts include, but are not limited to, America Online®, Yahoo®, Hotmail®, and Comcast®. In addition to publicly-available e-mail services such as these, e-mail hosts may be private or proprietary systems. For example, companies or government agencies may have e-mail servers that are inaccessible to the general public, but which can constitute e-mail hosts for the purposes of this application.

Likewise, search services 21a to 21c are typically implemented using servers (e.g., server farms) or other computers that maintain Web sites. Examples of search services for searching the Internet/WWW include, but are not limited to, Google®, Yahoo®, Hakia® and Lycos®. In addition to publicly-available search services, the search services used herein may be private or proprietary systems. For example, companies or government agencies may have servers that are inaccessible to the general public, and which can be used to search local databases, and remote database, such as the Internet/WWW.

Communications between cell phone 22 and central service 12 are typically wireless (e.g., over a cellular network 29). Communications may be effected in accordance with any type of cellular protocol, such as CDMA (Code Division Multiple Access) or GSM (Global System for Mobile Communications). For non-cellular devices, or for cellular devices with multiple functionalities, communications may be over any type of wireless link, such as a wireless fidelity (Wi-Fi) link, or wired link, such as Ethernet or telephone lines. Communications between central service 12 and e-mail hosts 20a to 20c may be over one or more network(s) 30, which may include the Internet, wide area networks (WANs), local area networks (LANs), and/or wireless networks. The same is true for communications between central service 12 and search services 21a to 21c. One or more such networks may also route communications between a cell phone and central service 12.

### Retrieving E-Mail

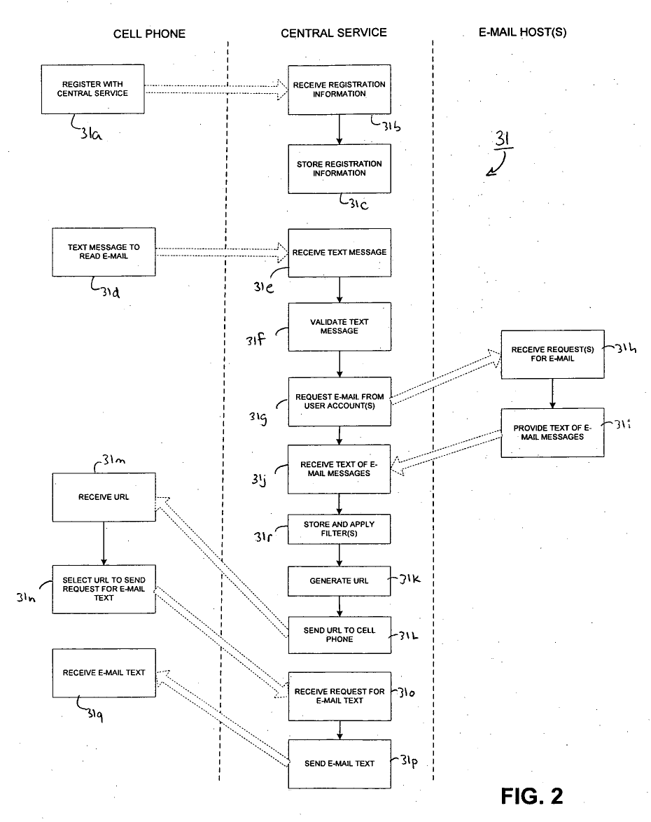

Referring to FIG. 2, a process 31 is shown for implementing e-mail retrieval. Process 31 may be implemented through computer program(s) 17 running in server 14 in conjunction with computer programs running on a cell phone (or other client). A description of process 31 is set forth below, along with modifications thereto.

According to process 31, a user of cell phone 22 registers (31a) with central service 12. Registration may occur in any number of ways. For example, a user may operate a networked computer to access a Web site associated with, e.g., hosted by, central service 12. A registration Web page (not shown) may require the user to enter registration information. The registration information may include, but is not limited to, a telephone number of the user's cell phone, e-mail accounts (e.g., e-mail addresses) from which the user would like to retrieve e-mail, and passwords of those accounts, if any. Other information may also be required for registration. For example, additional account identities and passwords may be provided, which may be used, e.g., to access proprietary e-mail systems. More specifically, often, a proprietary e-mail system includes a user account and a separate e-mail account. In such systems, central service 12 may require the identity of a user's account and its password and, if necessary, the identity of the user's e-mail account and its password.

In addition, the registration information may include information that identifies the user, e.g., for billing purposes. In this regard, one way of billing users for e-mail retrieval is to use a premium number as the text message number for retrieving e-mail. That is, the user may be billed a predefined amount each time the user texts a message to the premium number. The amount will simply appear on the user's cell phone bill. Another way of billing users for e-mail retrieval is to generate and send a bill to a user periodically, e.g., each month. In this case, the user's contact information, such as name, address, home telephone number, and credit card number(s) may be taken as registration information.

It is noted that the Internet-based registration information is not limited to the registration information described above, and that any type of registration information may be received. Also, the foregoing registration need not be Internet-based. For example, a user may fill-out a form with the user's registration information, and mail that form to a predefined address associated with central service 12. Alternatively, a user may register by speaking to an operator on a telephone and providing the necessary registration information. The operator may then enter the registration information on behalf of the user.

A user may also register with central service 12 using text messaging. For example, central service 12 may make a predefined text message, such as “GREET”, the registration message. In this case, a user texts the message “GREET” to a telephone number associated with central service 12. Central service 12 receives the text message and interprets the text message as a request to register for the e-mail retrieval service provided by central service 12. In this case, central service 12 may obtain the telephone number of the cell phone that sent the text message from data associated with the text message (e.g., the UDP header), and store that telephone number as evidence of registration. Central service 12 may also obtain other information about the user from the telephone number. For example, if available, the user's name, address, and other contact information may be stored.

In any case, after cell phone 22 sends the initial registration message, “GREET” in this example, central service 12 replies to cell phone 22 with a request to identify the addresses and passwords of e-mail accounts from which e-mail is to be retrieved. The user (via cell phone 22) replies by texting the name and password of each e-mail account. Additional information, such as that provided above via a Web page, may also be texted to the central service. Predefined text messages may be used to identify the e-mail accounts and passwords to central service 12. For example, “ADDRESS” may be used followed by an e-mail address, such as xxx@hotmail.com, e.g. “ADDRESS xxx@hotmail.com”. For passwords, the text message “PASSWORD” may be used, followed by a password. In this implementation, e-mail addresses and passwords may be texted as part of a back-and-forth communication session between cell phone 22 and central service 12. In alternative implementations, e-mail addresses and passwords may appear in the same text message, e.g., text “ADDRESS xxx@hotmail.com PASSWORD xyzabc”. Information for different e-mail accounts may appear in the same text message or in different text messages as part of back-and-forth communication (here text messaging) between central service 12 and cell phone 22. In other implementations, ordering of the text message fields may imply their content and, as a result, there is no need to text key words, such as “ADDRESS”. For example, central service 12 may be configured to recognize the text message “xxx@hotmail.com” followed by “xyzabc” as, respectively, the e-mail account from which e-mail is to be retrieved and the password for that account. In this regard, central service 12 may be configured to recognize any of the text messages described herein by order.

Central service 12 receives (31b) registration information for a user and stores (31c) the registration information, e.g., in association with the user's cell phone number. Thereafter, the user is considered registered, and may retrieve e-mail via central service 12. To retrieve e-mail, a user texts (31d), via cell phone 22, a predefined text message to central service 12. For example the predefined text message may be “READ”. Central service 12 receives (31e) the text message and identifies the cell phone from which it came. Central service 12 validates (31f) the text message to confirm that it came from a registered user. If the text message did not come from a registered user, central service 12 may send a text message back to cell phone 22, advising that registration is required before e-mail can be retrieved by central service 12. Registration instructions may be provided in the message.

Assuming that the text message came from a registered user, central service 12 retrieves the e-mail addresses and corresponding passwords from storage. Central service 12 uses this information to request (31g) e-mail messages from the e-mail host(s) using, e.g., POP (post office protocol) or any other protocol supported by the e-mail hosts. Central service 12 may be configured to retrieve e-mail according to one or more predefined priorities. In this regard, central service 12 may be configured to prioritize e-mail retrieval by account. For example, central service 12 may be configured to retrieve e-mail first from a work account, followed second from a lower priority account, and so on. Account priority may be provided to central service 12 by the user during registration.

In this implementation, central service 12 is configured to provide the latest ten unread e-mails from all accounts. For example, central service 12 may request all unread messages from all e-mail accounts, and then select only the ten newest unread e-mail messages to be provided to the user. Alternatively, central service 12 may request the latest ten unread messages from a first e-mail account and, if there are less than ten, request additional e-mail messages from additional accounts according to account priority until there are ten messages. In other implementations, more or less than ten e-mail messages may be requested and provided to the user. Exactly how many e-mail messages are retrieved, and the order of accounts from which they are to be retrieved, may be set by the user when providing registration information. This information may, of course, be updated, e.g., if a user no longer uses a particular account or wants to change account priorities. Central service 12 may be configured to recognize one or more predefined text messages for updating registration information; e.g., “UPDATE”, “UPDATE ADDRESS”, etc.

In any case, following validation of the received “READ” message, central service 12 requests (31g) e-mail from one or more of e-mail hosts 20a to 20c. As explained above, the number of e-mail messages requested and the e-mail host priorities may be set by the user. The e-mail host(s) receive (31h) the request(s) from central service 12. A request may include, for each e-mail host, the e-mail address, which identifies the user's account, and the password of that account. Other information, such as other passwords, and the like may also be provided if needed. Communications may be exchanged between central service 12 and the e-mail host(s) if additional information is required. Each e-mail host may perform whatever validations are required on a received e-mail address and password. After validations are performed, the e-mail host(s) provide (31i) text of e-mail messages to central service 12. For example, text for the latest ten e-mail messages may be provided.

Central service 12 receives (31j) text for the e-mail messages from one or more of the e-mail host(s), assuming that there is text to retrieve. E-mail data in addition to text may be retrieved as well. For example, attachments, such as still images, video, audio, word processing documents (e.g., MS Word® documents), and the like may also be retrieved. As explained above, the e-mail messages may be a predefined number of unread messages (e.g., ten) or the e-mail messages may include all unread (or, in some implementations, previously-read) e-mail messages. In this implementation, central service 12 stores text for the received e-mail messages in memory, applies any filters to the stored text (as described below) (31r), and generates (31k) a uniform resource locator (URL), which enables access to those messages via hypertext transfer protocol (HTTP). In this implementation, the URL directs the user to the previous ten unread messages. If a user would like more e-mail, the user must text “READ” again, e.g., to retrieve the next ten unread messages, and so on. In other implementations, the URL may direct the user to more or less than ten messages (e.g., all unread e-mail messages).

In any case, after central service 12 generates the URL, central service 12 sends (31l) the URL to cell phone 22. Cell phone 22 receives (31m) the URL, whereafter the user may select (31n) the URL in order to retrieve the corresponding e-mail messages. In particular, a user may click on the URL using whatever control options are available on cell phone 22. Through this URL, central service 12 may obtain information about cell phone 22 in order to personalize the information available for that particular type of cell phone, and to maintain compatibility with cell phone 22.

Cell phone 22 receives the selection of the URL and sends (31n) data to central service 12 (e.g., via HTTP) requesting the e-mail messages associated with the URL. Central service 12 receives (31o) this data, which identifies the URL, and retrieves text for the messages associated with the URL. Central service sends (31p) the text to cell phone 22, where the text is received (31q). As explained above, if the user would like additional e-mail, the user may text “READ” to central service again from cell phone 22, thereby obtaining additional e-mail (if any exists). If there is no additional e-mail, unread or otherwise, central service may appropriately notify the user, e.g., by sending a text message to cell phone 22, such as “INBOX EMPTY”.

It is noted that the text messages such as “GREET” and “READ” are examples of messages that may be used for registration and reading e-mails, respectively. Other messages may be used in addition to, or instead of, these particular messages.

Thus, by clicking on the URL described above, a user “pulls” text for e-mail messages from central service 12 to cell phone 22. The URL may remain valid for a predetermined period of time, after which the URL may expire. In one implementation, a current URL remains valid until the user requests more e-mail , e.g., texts “READ”, as described above, to central service 12, after which the user receives a new URL for accessing additional e-mail. In other implementations, a URL may remain valid even after a new URL is provided to the user for different e-mail messages. A user may determine how/when a URL expires by providing appropriate instructions during registration.

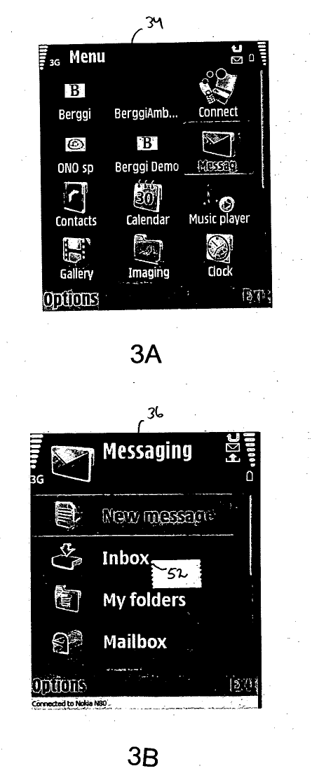

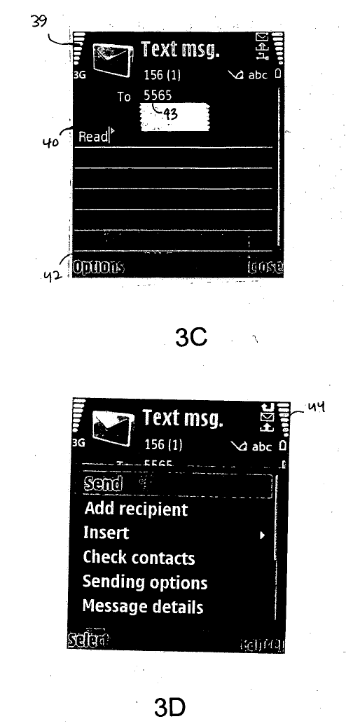

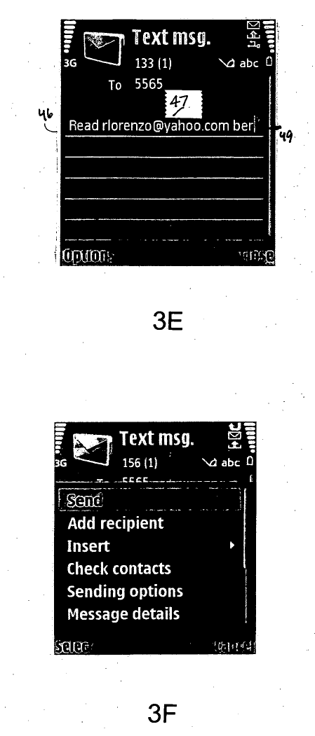

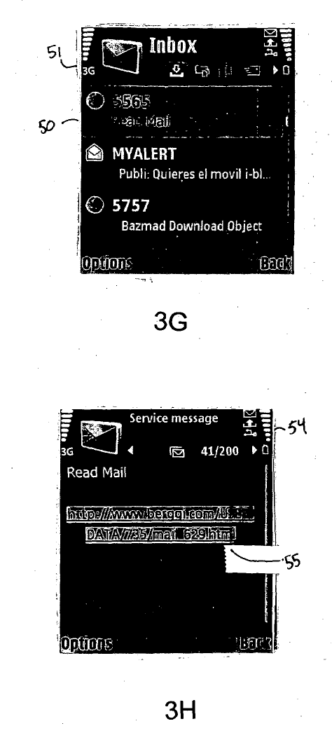

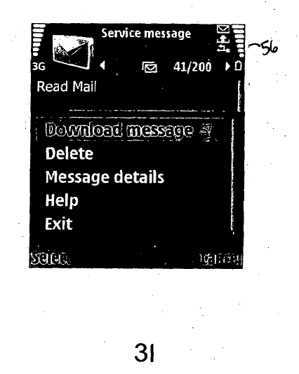

FIGS. 3A to 3I show examples of graphical user interfaces (GUIs) generated by a cell phone, which may be used to implement at least part of process 31. To begin, GUI 34 shows icons for accessing various services via a cell phone. Among these services is the text messaging service used to implement the e-mail retrieval service described herein. Icon 35 is for activating the text messaging service. Clicking on icon 35 results in the display of GUI 36, shown in FIG. 3B. GUI 36 contains icons for selecting various functions associated with text messaging. Icon 37 is for writing a new text message. In this case, a user selects icon 37, which results in the display of GUI 39 (FIG. 3C). In GUI 39, a user texts a message 40 to a particular number 43, both of which (the message and number) are provided by the user. In this example, the message is “READ”, as described above. The user selects “Options” 42, in order to produce the display of GUI 44 (FIG. 3D). GUI 44 includes various options for processing the text message. Among these options is send 45, which allows the user to send the text message to central service 12, which the user may do in order to read current e-mail messages (e.g., the ten latest).

FIGS. 3E and 3F shows additional examples of GUIs 39 and 44, respectively. In FIGS. 3E and 3F, a user texts, to central service 12, READ 46, followed by an e-mail account 47 (a Yahoo® account in this example), followed a password 49 for that account. In response to that text message, central service replies, in accordance with process 31, with a message 50, which is shown in GUI 51 of FIG. 3G, and which is an e-mail message entitled “Read Mail”, in this example. A user accesses message 50 by navigating to, and selecting, Inbox 52 of FIG. 3B. A user may select message 50, which contains a URL to the user's e-mail (as described above), and which is displayed in GUI 54 of FIG. 3H. Selection of URL 55 results in display of GUI 56 of FIG. 3I. In GUI 56, a user is prompted to download e-mail message(s) associated with URL 55. Upon selecting download message 57, the messages are sent from central service 12 to the user's cell phone.

As explained above, e-mail messages are routed from one or more of e-mail hosts 20a to 20c to cell phone 22 through central service 12. Central service 12 may be configured with one or more filters in order to sort, select, prioritize, or identify e-mail messages. These filters may include one or more computer program(s) 35 that are stored in memory 16 and that are executed by processor(s) 15.

Referring to FIG. 1, central service 12 may include a filter 36 to examine the “From” line of retrieved e-mail messages in order to identify those e-mail messages from a particular source, e.g., person. Filter 36 may then associate, with the URL, only those messages that are identified as having come from the source. The user may set the source beforehand, e.g., in the registration information or the user may text the identity of the source to central service 12. A new identity may be texted each time the user wants to read e-mail. For example, a user may text the message “READ PAUL” or “READ FROM PAUL” to central service 12. Central service 12, in response, requests a predefined number of e-mail messages from one or more e-mail hosts 20a to 20c. After the text for those messages is retrieved, filter 36 examines the “From” line of each message in order to identify only those that came from Paul. Central service 12 generates a URL that provides access only to those e-mail messages that came from Paul. If, for example, central service 12 is configured to retrieve ten e-mail messages, and the user requests messages only from Paul, central service 12 may have to request additional e-mail messages, if available, from e-mail hosts 20a to 20c, in order to obtain the quota of ten e-mail messages.

Filter 36 may identify e-mail from more than one source. For example, texting the message “READ FROM PAUL JOHN” to central service 12 instructs filter 36 to identify e-mail messages from either Paul or John, and to process those messages as described above. Filter 36 may be extended to identify messages from any number of sources.

Central service 12 may include a filter 37 to examine the “Subject” line of e-mail. For example, a user may text “READ SUBJECT PATENT” in order to obtain e-mail messages having the word patent in their “Subject” lines. The operation of filter 37 is similar to that described above in that it examines the subject lines of e-mail text, and may require requesting additional e-mail messages if the user quota (e.g., ten) has not been fulfilled.

Central service 12 may include a filter 39 to examine the entirety of e-mail message text for one or more words. For example, texting the message “READ TEXT PATENT” to central service 12 instructs filter 39 to identify e-mail messages that contain the word patent anywhere in their text. As above, multiple words may be used, e.g., “READ TEXT PATENT CIRCUIT” to identify e-mail messages containing the words patent or circuit.

The filters described above are merely examples, and any types of filters may be incorporated into central service 12 for searching, sorting, prioritizing, etc. received e-mail messages. Furthermore, conjunctions, such as “and” and “or” may be included in the text messages in order to further refine processing performed by the filters. For example, texting “READ TEXT PATENT AND CIRCUIT” would result in retrieving only e-mail messages containing both the words patent and circuit, whereas texting “READ TEXT PATENT OR CIRCUIT” would result in retrieving e-mail messages containing either of the words patent or circuit. Texting “READ TEXT NOT PATENT” would result in retrieving e-mail messages that do not contain the word patent anywhere in the text.

Central service 12 may also allow a user to subscribe to receive a predetermined number of e-mail messages on a cell phone at a predetermined time. Central service 12 may recognize a predefined text message in order to implement the subscription service. For example, central service 12 may be configured to recognize the text message “SUBSCRIBE” to trigger an e-mail retrieval subscription. The process for subscribing to e-mail retrieval may be similar to process 31 above. That is, a user of cell phone 22 texts “SUBSCRIBE” to central service 12. Central service 12 receives the text message, validates the text message, and requests e-mail messages from the user's e-mail account. In this case, the e-mail messages may be requested at a frequency associated with the subscription. For example, the e-mail messages may be requested once a day at 6:00 PM, or at any other predefined interval. The same subscription interval may be provided for all users, or individual users may provide a custom subscription interval or intervals in their registration information. Alternatively, the subscription interval may be provided in the text message itself. For example, a user of cell phone 22 may text “SUBSCRIBE DAILY” in order to obtain daily e-mail messages via central service 12. A user of cell phone 22 may text “SUBSCRIBE DAILY 5:00 PM” in order to obtain daily e-mail messages via central service 12 at 5:00 PM. In some implementations, central service 12 and the user may have a dialogue in order to determine exactly when such e-mail messages are to be provided. For example, a user of cell phone 22 may text “SUBSCRIBE” to central service 12. In response to this text message, central service 12 may request the subscription interval, e.g., hourly, twice daily, daily, every other day, weekly, monthly, etc. The user may text a reply from cell phone 22. Central service may then respond with a request for the time at which e-mail messages are to be delivered (or, more precisely, a URL linking to text for those e-mail messages). The user may text a reply with a specified time or times at which the URL is to be delivered to cell phone 22.

The foregoing subscription service may be combined with one or more filters in order to provide a user with additional customization options for retrieving e-mail messages. For example, a user of cell phone 22 may text “SUBSCRIBE FROM PAUL” in order to subscribe to e-mail messages via central service 12 that are from Paul, i.e., that contain Paul in the subject line. That is, in response to such a text message, central service 12 would retrieve e-mail messages periodically that contain Paul in the subject line, and provide a URL to those e-mail messages to the user's cell phone. Any of the foregoing filters may be combined with any aspect of the subscription service described herein in order to allow a user to customize e-mail delivery. For example, a user of cell phone 22 may text “SUBSCRIBE FROM PAUL OR JOHN DAILY 6:00 PMEST” in order to obtain e-mail messages from Paul or John daily at 6:00 PM Eastern Standard Time.

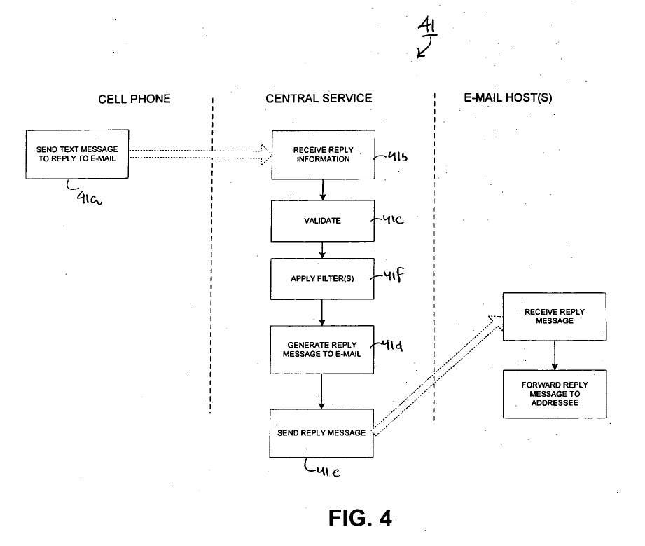

Referring to FIG. 4, central service 12 may also be configured to enable a cell phone user to reply to e-mail messages. More specifically, a user receives text of an e-mail messages in accordance with process 31 of FIG. 2. Each e-mail message may include an associated identifier that is assigned by central service 12, e.g., “Message1”, “Message2”, etc. A user of cell phone 22 may use text messaging to select one of these messages and to reply to the selected message, as shown in process 41 of FIG. 4. As shown, a user of cell phone 22 texts (41a) a predefined text message in order to reply to an e-mail, possibly with one or more arguments identifying the e-mail and the reply text. In one implementation, a user first sends a text message and then the e-mail text. In other implementations, there is a communication process between cell phone 22 and central service 12 that enables central service to obtain the information it needs to formulate an e-mail reply.

By way of example, a user of cell phone 22 may text “REPLY MESSAGE1” to central service 12. Central service 12 is configured to recognize that the text message “REPLY” is for replying to an e-mail message. Central service 12 is also configured to recognize the number of cell phone 22, and the argument “MESSAGE1”, i.e., that MESSAGE1 relates to a particular stored e-mail for cell phone 22. In response, central service sends cell phone 22 a request for the reply text. A user of cell phone 22 sends the reply text to central service 12 via a text message. In another implementation, a user of cell phone may simply text “REPLY”, whereafter central service requests that the user identify the message being replied to, and provide the reply text. In another implementation, all of this information may be provided in a single, initial text message. For example, a user may text “REPLY MESSAGE1 [reply text]”, where “REPLY” indicates a reply to an e-mail message, “MESSAGE1” identifies the message being replied to, and “[reply text]” is the text that is to be included in the reply message.

In any case, central service 12 receives (41b) the reply information from cell phone 22, and validates (41c) it, e.g., to confirm that cell phone 22 (or a user thereof) is registered. Assuming validation, central service 12 applies (41f) any filters to the reply (e.g., to identify the response address), generates (41d) a reply to the e-mail message identified in the text message. By way of example, central service 12 parses the original e-mail message (which is stored in memory that is accessible to central service 12) in order to identify a response address to the e-mail message. Central service 12 uses the response address and e-mail text to formulate the reply message. Central service 12 sends (41e) the reply message to the recipient, e.g., over the Internet or any other wired and/or wireless network. The reply message is typically routed to the original e-mail host, and then to the recipient/addressee.

The foregoing describes incorporating only text into the reply message. However, other data may also be included in the reply message. For example, the reply message may include still images, audio, video, or any other type of information that may be transmitted over a network. Appropriate text messages may be defined to accommodate such data. For example, “REPLY MESSAGE1 IMAGE [attached image]” may be used to send a reply to message #1 attaching an image, which is here labeled “attached image”.

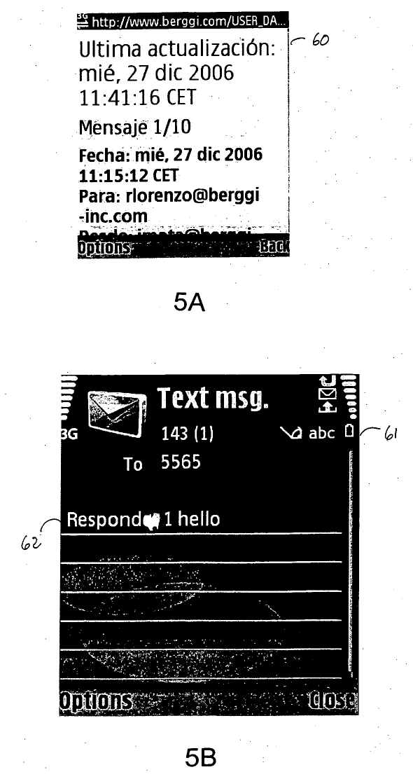

FIG. 5A shows an example of an e-mail message 60. FIG. 5B shows a GUI 61 for use in sending a reply to e-mail message 60. More specifically, a user selects the text messaging icons of FIGS. 3A and 3B, and texts a reply 62 to e-mail message 60. Reply 62 includes a predefined word for replying to e-mail messages, here “RESPOND”, an identification of the text message, here “1”, and text for the reply, here “hello”. A user then sends this reply 62 to central service 12, which generates a reply to e-mail message 60 in accordance with process 41 of FIG. 4.

### Searching a Database

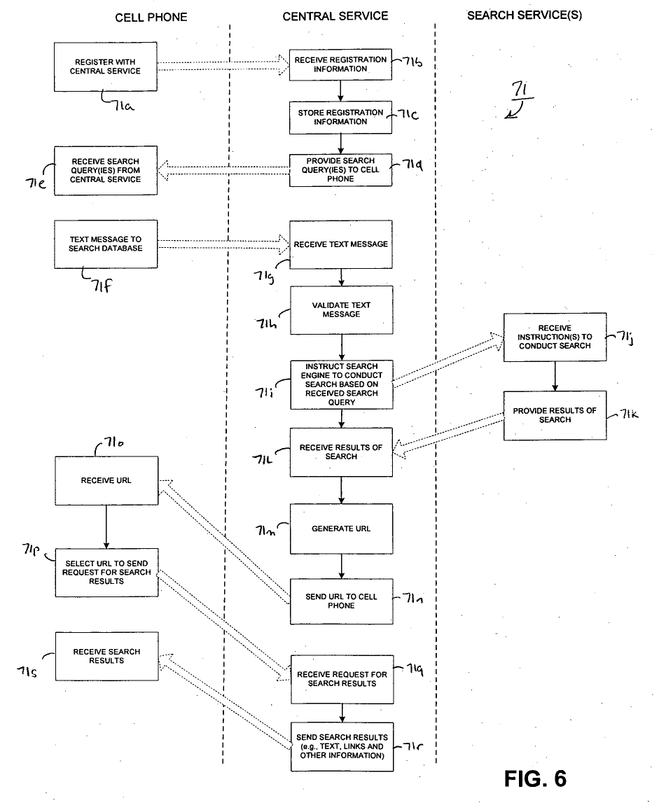

Referring to FIG. 6, a process 71 is shown for searching a database using an electronic device, such as a cell phone. Process 71 may be implemented through computer program(s) 17 running in server 14 in conjunction with computer programs running on a cell phone (or other client). A description of process 71 is set forth below, along with modifications thereto.

According to process 71, a user of cell phone 22 registers (71a) with central service 12. Registration may be performed in any of the manners described above with respect to FIG. 2. Registration for the database search service of process 71 may be performed at the same time as registration for the e-mail retrieval service, or at a different time. Furthermore, some of the registration information for the database search service may be different than that for the e-mail retrieval service. For example, registration information for database searching may include one or more search services to use for the searching.

Examples of the search services may include search engines by Google®, Lycos®, Hakia® and Yahoo®. The registration information may also include one or more public or private databases to be searched, e.g., the Internet, an intranet, or the like, along with any user identifiers (IDs) and passwords needed to access such databases. If no database is specified in the registration information, the default database to search may be the Internet. In this regard, the following example describes process 71 in the context of Internet searching.

Central service 12 receives (71b) registration information for a user and stores (71c) the registration information, e.g., in association with the user's cell phone number. Thereafter, the user is considered registered. Following registration, central service 12 may provide (71d) cell phone 22 with one or more search queries. For example, central service 12 may text the search queries to cell phone 22 or central service 12 may generate a hyperlink to the search queries and send that hyperlink to cell phone 22. A user at cell phone 22 may then select the hyperlink in order to receive (71e) the search queries, e.g., to download the search queries to cell phone 22 for later use.

One or more of the search queries may be incomplete. For example, the search queries may include questions that contain blanks, which are to be filled in by a user. Examples of incomplete search queries include, but are not limited to:

Where is ______ located?

What is ______?

Who is ______?

What time is ______?

How much does ______ cost?

I would like a picture of ______.

Where can I find ______?

What is the latest news regarding ______?

Any number of questions may be provided. Furthermore, the questions may be provided in the native language of the cell phone user. The native language of the cell phone user may be provided to the central service as part of the initial registration information.

In addition to incomplete search queries, central service 12 may provide complete search queries, which may or may not be tailored to the user based on the user's registration information. For example, in the registration information, the user may be identified as a resident of Boston. Accordingly, examples of completed search queries may include “What is the weather for Boston”, or “What musical events are occurring in Boston”. Similarly, the user may be identified as a baseball fan in the registration information. Examples of completed search queries may include “What baseball games are on television tonight” or “Did the Red Sox win last night” (which also depends the user's residence).

To generate such queries, central service 12 may use a predefined list of incomplete queries (which may, or may not, be different than the list provided to the user), and complete those queries with information obtained from the user's registration information. A user may be prompted, at registration, to select whether or not to receive such queries.

The complete search queries may also be independent of the registration information. Examples of such queries may include “What is on television tonight” and “What are the latest news headlines”. Generic queries, such as these, may be altered so that they are user-specific. For example, “What are the latest news headlines” may be revised, by central service 12 or the user at cell phone 22, to “What are the latest news headlines in Boston”.

To conduct a search, a user texts (71f), via cell phone 22, a text message to central service 12. The text message may be a predefined text message, such as “SEARCH”. In this example, a user texts the message “SEARCH” to a telephone number associated with central service 12. Central service 12 receives (71g) the text message and interprets the text message as a request to search one or more default or predefined databases. The initial text message may include a search query, or central service 12 may send a message back to cell phone 22 requesting a search query. For example, the user may text “SEARCH Did the Red Sox win last night”. Alternatively, the user may text “SEARCH”, receive a prompt from central service 12, then text “Did the Red Sox win last night” in response.

The search query may include one or more of the search queries received from central service 12. Alternatively, the search query may be a search query that was pre-stored on cell phone 22 (e.g., some cell phones may come with search queries pre-installed). If the search query was a previously-incomplete search query, the user may complete the search query when sending the text message. For example, if the search query was “Where is ______ located?”, when texting, the user may complete the search query as follows: “Where is Harvard University located”, in order to have a search conducted for the location of Harvard University.

Central service 12 receives (71g) the text message (and search query) and identifies the cell phone from which the text message came. Central service 12 validates (71h) the text message to confirm that it came from a registered user. If the text message did not come from a registered user, central service 12 may send a text message back to cell phone 22, advising that registration is required before e-mail can be retrieved by central service 12. Registration instructions may be provided in the message.

Assuming that the text message came from a registered user, central service 12 instructs (71i) one or more of search services 21a to 21c to conduct a search using the received search query. Central service may use predefined search service(s) or those specified in the user's registration information. Alternatively, a user may text the identity of a search service to central server 12, either along with the search query or separate from the search query. The search service(s) receive (71j) the instruction(s) from central service 12, along with the search query (or queries). The search service(s) conduct a search based on the search query (or queries), and provide (71k) the results of the search to central service 12. The search results may include text, images, hyperlinks, or the like.

Central service 12 receives (71l) the search results from the search service(s). In this implementation, central service 12 stores the search results, and generates (71m) a URL, which enables access to the search results via HTTP. By way of example, the search results may include text, hyperlinks, video, still images, audio, tables, or any other information that is retrievable from a database. Central service 12 sends (71n) the URL to cell phone 22. Cell phone 22 receives (71o) the URL, whereafter the user may select (71p) the URL in order to retrieve the search results. In particular, a user may click on the URL using whatever control options are available on cell phone 22. Cell phone 22 receives the selection and sends (71p) data to central service 12 (e.g., via HTTP) requesting the search results associated with the URL. Central service 12 receives (71q) this data, which identifies the URL, and retrieves the search results associated with the URL. Central service sends (71r) the search results to cell phone 22, where the search results are received (71s). Thus, by clicking on the URL described above, a user “pulls” search results from central service 12 to cell phone 22. As was the case above, the URL may remain valid for a predetermined period of time, after which the URL may expire. In one implementation, a current URL remains valid until the user orders another search. In other implementations, a URL may remain valid even after a new URL is provided to the user for different e-mail messages. A user may determine how/when a URL expires by providing appropriate instructions during registration.

As explained above, search results are routed from one or more of search services 21a to 21c to cell phone 22 through central service 12. Central service 12 may be configured with one or more filters in order, e.g., to sort, select, prioritize, or identify the search results. These filters may include one or more computer program(s) 35 that are stored in memory 16 and that are executed by processor(s) 15. For example, the filters may sort search results according to date and/or time, e.g., to provide the most recent (e.g., current) information, such as today's weather or today's headlines. The filters may also modify searches based on, e.g., registration information of a user. For example, if the user's search query is “What is the weather forecast”, central service 12 may be configured to augment that search query with the residence of the user, e.g., so that the search query actually sent to a search service is “What is the weather forecast for Boston”, where “for Boston” is added automatically by the filter prior to sending the search query. Similarly, if a user texts a search query for “What movies are playing tonight”, a filter may augment the search query with the date and/or street address or zip code of the user (taken, e.g., from the registration information). This may be used to obtain showings at cinemas that are most local to the user.

The filters also may be used to sort search results, e.g., based on user's registration information. For example, a user may send the search query “What is the score of last night's game”. If the user's registration information indicates that the user is from Boston, a filter may either augment the search query with relevant Boston teams, such as “What is the score of last night's Red Sox game”, where “Red Sox” is added automatically by the filter prior to sending the search query. Alternatively, central service 12 may send the search query, as is, i.e., “What is the score of last night's game”. Upon receiving the search results, which presumably will include scores of various sports games from the previous night, a filter may search through the results in order to find a score for last night's Red Sox game. This process may be further refined. For example, if the user's registration information indicates that the user is a football fan, the filter may search the results for Patriot's scores instead of scores for other Boston teams.

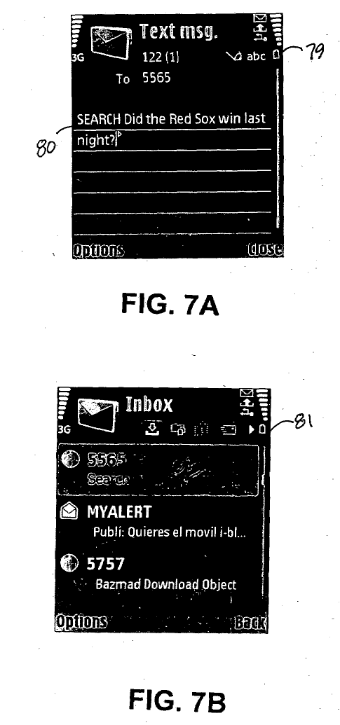

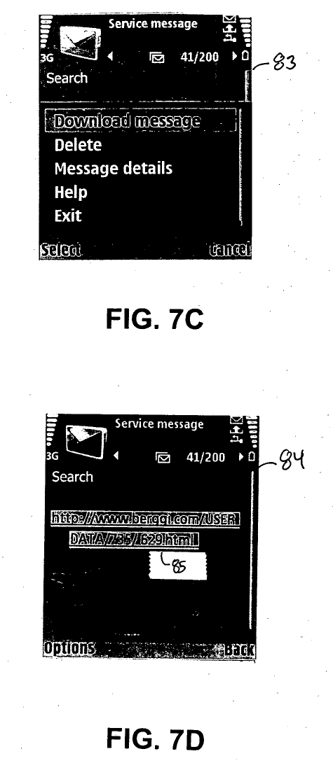

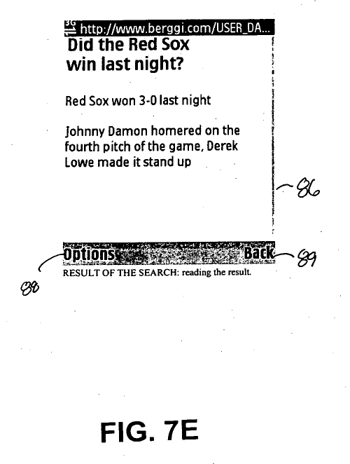

FIGS. 7A to 7E show graphical user interfaces generated by a cell phone, which may be displayed during the course of the process shown in FIG. 6. FIG. 7A shows a GUI 79 containing a text message 80. Text message 80 is sent to central service 12, which uses that text message to search the Internet (e.g., Web pages and other documents, databases, and the like) for information pertaining to the test message (the search query). Search results are generated for the search query in accordance with process 71 of FIG. 7. Once search results are obtained, central service 12 provides those search results to the user's cell phone, which displays GUI 81 of FIG. 7B. A user may navigate to, and select, option 82 to retrieve the search results. Upon selecting option 82, GUI 83 of FIG. 7C is displayed. GUI 83 includes an option to download a message containing the search results. Upon downloading the message, GUI 84 of FIG. 7D is displayed. GUI 84 contains a URL 85 that links to the search results produced by process 71. To access the search results, the user selects URL 85. In response, the cell phone displays the search results, which are shown in the GUI 86 of FIG. 7E. A user may navigate to additional search results, e.g., by scrolling down the GUI or by selecting appropriate options 88, 89.

### Implementations

The processes of FIGS. 2, 4 and 6, and the various modifications described herein (hereinafter, “the processes”), are not limited to use with any particular hardware, software, or programming language. They may find applicability in any computing or processing environment and with any type of machine that is capable of running machine-readable instructions. All or part of the processes can be implemented in digital electronic circuitry, or in computer hardware, firmware, software, or in combinations thereof. Hardware on the client and/or server side may be, e.g., part of a desktop or laptop personal computer, a personal digital assistant (PDA), a cellular or other mobile telephone, a personal media player, etc.

All or part of the processes can be implemented as a computer program product, e.g., a computer program tangibly embodied in an information carrier, e.g., in one or more machine-readable storage media or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Actions associated with the processes can be performed by one or more programmable processors executing one or more computer programs to perform the functions of the processes. The actions can also be performed by, and the processes can be implemented as, special purpose logic circuitry, e.g., an FPGA (field programmable gate array) and/or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only storage area or a random access storage area or both. Elements of a computer include a processor for executing instructions and one or more storage area devices for storing instructions and data. Generally, a computer will also include, or be operatively coupled to receive data from, or transfer data to, or both, one or more mass storage devices for storing data, e.g., magnetic, magneto-optical disks, or optical disks. Information carriers suitable for embodying computer program instructions and data include all forms of non-volatile storage area, including by way of example, semiconductor storage area devices, e.g., EPROM, EEPROM, and flash storage area devices; magnetic disks, e.g., internal hard disks or removable disks; magneto-optical disks; and CD-ROM and DVD-ROM disks.

All or part of the processes can be implemented in a computing system that includes a back-end component, e.g., as a data server, or that includes a middleware component, e.g., an application server, or that includes a front-end component, e.g., a client computer having a graphical user interface, or any combination of such back-end, middleware, or front-end components. The components of the system can be interconnected by any form or medium of digital data communication, e.g., a communication network. Examples of communication networks include a LAN and a WAN, e.g., the Internet.

Actions associated with the processes can be rearranged and/or one or more such actions can be omitted to achieve the same, or similar, results to those described herein.

As explained above, the processes described herein are not limited to use with the particular text messages provided above. Any text messages may be defined.

The processes are not limited to providing a URL containing a link to e-mail messages. In other implementations, central service 12 may simply provide the e-mail text once it is received from the e-mail host, without generating and providing a URL. This may be referred to as a “push” implementation, in that the central service “pushes” e-mail text to the cell phone (as opposed to the “pull” implementation described above, where the users obtains the e-mail text by selecting a URL provided by the central service). In other implementations, central service 12 may provide a way to access the e-mail text other than a URL.

Similarly, the processes are not limited to providing a URL containing a link to search results. In other implementations, central service 12 may simply provide the search results once they are received from the search service(s), without generating and providing a URL. This may be referred to as a “push” implementation, in that the central service “pushes” search results to the cell phone (as opposed to the “pull” implementation described above, where the users obtains the search results by selecting a URL provided by the central service). In other implementations, central service 12 may provide a way to access the search results other than a URL.

Communication between a cell phone and central service 12 is not limited solely to text messaging. Any form of communication between a cell phone and the central service may be used for exchange of information in order to implement the processes.

The processes described herein are not limited to retrieving e-mail or search results, but rather may be used to retrieve any information that is accessible over the Internet. For example, the processes may be used to retrieve files or other data.

All or part of processes 31, 41 and/or 71 may be combined in an overall process. Portions of one of more of these processes may be omitted in individual processes or in a combined process.

Elements of different implementations described herein may be combined to form other implementations not specifically set forth above. Other implementations not specifically described herein are also within the scope of the following claims.

What is claimed is:

1. A method of searching a database using an electronic device, comprising:
receiving a first text message from the electronic device;
providing a first search query to the electronic device in response to the first text message, the first search query being incomplete;
receiving a second text message from the electronic device, the second text message comprising a second search query, the second search query comprising a completed version of the first search query;
using the second search query to obtain a search of the database; and
providing results of the search to the electronic device.

2. The method of claim 1, further comprising:
providing multiple search queries to the electronic device in response to the first text message, the multiple search queries being provided with the first search query, at least some of the multiple search queries being incomplete.

3. The method of claim 1, further comprising:
receiving a third text message from the electronic device, the third text message comprising a third search query, the third search query comprising one of the multiple search queries that is not incomplete;
conducting a search of the database using the third search query; and
providing results of the search conducted using the third search query to the electronic device.

4. The method of claim 1, further comprising:
generating a hyperlink to the results of the search;
wherein providing the results of the search comprises providing the hyperlink to the electronic device.

5. The method of claim 1, wherein the electronic device comprises a mobile telephone and the database comprises the Internet.

6. The method of claim 1, wherein the first search query comprises a question having a blank portion.

7. The method of claim 6, wherein the second search query comprises the question with the blank portion filled-in.

8. A method of searching the Internet using a cellular telephone, comprising:
receiving a text message from the cellular telephone;
using the text message to obtain information from the Internet;
providing the information to the cellular telephone.

9. The method of claim 8, further comprising:
generating a hyperlink to the information;
wherein providing the information comprises providing the hyperlink to the cellular telephone.

10. The method of claim 8, wherein the text message comprises a search query, and wherein using the text message to obtain information comprises using at least part of the search query to interact with a search engine to obtain a search of the Internet.

11. One or more machine-readable media for storing instructions to search a database using an electronic device, the instructions for causing one or more processing devices to:
receive a first text message from the electronic device;
provide a first search query to the electronic device in response to the first text message, the first search query being incomplete;
receive a second text message from the electronic device, the second text message comprising a second search query, the second search query comprising a completed version of the first search query;
use the second search query to obtain a search of the database; and
provide results of the search to the electronic device.

12. The one or more machine-readable media of claim 11, further comprising instructions for causing the one or more processing devices to:
provide multiple search queries to the electronic device in response to the first text message, the multiple search queries being provided with the first search query, at least some of the multiple search queries being incomplete.

13. The one or more machine-readable media of claim 11, further comprising instructions for causing the one or more processing devices to:
receive a third text message from the electronic device, the third text message comprising a third search query, the third search query comprising one of the multiple search queries that is not incomplete;
conduct a search of the database using the third search query; and
provide results of the search conducted using the third search query to the electronic device.

14. The one or more machine-readable media of claim 11, further comprising instructions for causing the one or more processing devices to:
generate a hyperlink to the results of the search;
wherein providing the results of the search comprises providing the hyperlink to the electronic device.

15. The one or more machine-readable media of claim 11, wherein the electronic device comprises a mobile telephone and the database comprises the Internet.

16. The one or more machine-readable media of claim 11, wherein the first search query comprises a question having a blank portion.

17. The one or more machine-readable media of claim 16, wherein the second search query comprises the question with the blank portion filled-in.

18. One or more machine-readable media for storing instructions to search the Internet using a cellular telephone, the instructions for causing one or more processing devices to:
receive a text message from the cellular telephone;
use the text message to obtain information from the Internet;
provide the information to the cellular telephone.

19. The one or more machine-readable media of claim 18, further comprising instructions for causing the one or more processing devices to:
generate a hyperlink to the information;
wherein providing the information comprises providing the hyperlink to the cellular telephone.

20. The one or more machine-readable media of claim 18, wherein the text message comprises a search query, and wherein using the text message to obtain information comprises using at least part of the search query to interact with a search engine to obtain a search of the Internet.

21. A system comprising:
memory to store instructions that are executable; and
one or more processing devices to execute the instructions to:
receive a first text message from the electronic device;
provide a first search query to the electronic device in response to the first text message, the first search query being incomplete;
receive a second text message from the electronic device, the second text message comprising a second search query, the second search query comprising a completed version of the first search query;
use the second search query to obtain a search of the database; and
provide results of the search to the electronic device.
receive a third text message from the electronic device;
retrieve e-mail from one or more e-mail accounts in response to the third text message;
generate a hyperlink to the e-mail; and
send the hyperlink to the electronic device.
